(19) United States
(12) Patent Application Publication
(10) Pub. No.: US 2008/0239460 A1
(43) Pub. Date: Oct. 2, 2008

(54) METHOD OF DRIVING ORGANIC TRANSISTOR AND ELECTROPHORETIC DISPLAY DEVICE

(75) Inventors: Hikari SHIMIZU, Suwa (JP); Tsutomu MIYAMOTO, Shiojiri (JP); Soichi MORIYA, Chino (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/054,927

(22) Filed: Mar. 25, 2008

(30) Foreign Application Priority Data
Mar. 29, 2007 (JP) 2007-086790

(51) Int. Cl. G02B 26/00

(52) U.S. Cl. 359/296; 345/107

(57) ABSTRACT

Provided is a method of driving an organic transistor formed on a substrate, wherein the substrate is sealed by a sealing material, and a bias voltage for compensating for threshold voltage of the organic transistor is supplied to the organic transistor at least at the time of an operation of the organic transistor.

### BACKGROUND

1. Technical Field

The present invention relates to a method of driving an organic transistor and an electrophoretic display device.

2. Related Art

Recently, a non-emission type display device having a flexible structure has been used as a display device used for an apparatus requiring flexibility, such as electronic paper. As such a non-emission type display device, an electrophoretic display device using an electrophoretic phenomenon is employed. Here, the electrophoretic phenomenon indicates that, when an electric field is applied to a dispersion system in which particles (electrophoretic particles) are dispersed in liquid (dispersion medium), the particles migrate by Coulomb force.

The driving of the electrophoretic display device is performed by driving a thin-film transistor to vary a voltage between electrodes, which face each other with electrophoretic particles interposed therebetween, and generating an electric field between the electrodes. In an electrophoretic display device requiring flexibility, an organic thin-film transistor (organic TFT) having flexibility is generally used as the thin-film transistor.

However, the organic TFT is susceptible to be influenced by an environmental atmosphere and more particularly humidity. For example, when the organic transistor is operated in a humid atmosphere, as shown in FIG. 10, an original relationship between a gate voltage VG and drain current Id (characteristic curve a) is changed to a relationship (characteristic curve b) in which a threshold voltage Vth is shifted in a direction denoted by an arrow f according to accumulation of the number of operations.

A mechanism for the minus shift of the threshold voltage Vth is generally explained as a phenomenon due to the trap of a carrier (charge). In more detail, the carrier (hole) in a p-type organic semiconductor (organic semiconductor layer) is a radical cation in which one electron is lost from π electrons in a neutral state and a positive ion (cation) and an unpaired electron (radical) exist. The radical cation functions as the carrier by repeatedly performing an operation for taking the electron from another neutral molecule, generating a new radical cation and returning to a neutral state, with respect to an electric field direction. However, if a water molecule (moisture) exists in the organic semiconductor, a charge transfer (weak charge interaction) state occurs in the radical cation and the water molecule. Since this state is a quasi-stable state in energy, larger activation energy is necessary for returning the radical cation to the neutral state. Accordingly, the radical cation is fixed while holding the positive charge and cannot function as the carrier. Accordingly, the amount of current flowing between a source electrode and a drain electrode is reduced and thus the minus shift of the threshold voltage Vth occurs.

That is, the organic TFT driven in the environmental atmosphere having humidity varies the threshold voltage Vth of the organic TFT according to the accumulation of the number of operations of the organic TFT, and the variation in threshold voltage Vth may deteriorate display capability of the electrophoretic display device.

Accordingly, a method of preventing display capability of an electrophoretic display device from deteriorating due to moisture (humidity) was suggested (JP-A-2005-31541). In JP-A-2005-31541, a upper substrate made of a transparent resin film and having a transparent electrode and a lower substrate made of a transparent resin film and having an organic TFT faced each other with spacers interposed therebetween, and black particles charged with a negative polarity, white particles charged with a positive polarity and a particle-shaped drying agent were dispersed and filled in an air layer ensured by the spacers, thereby performing dehumidification. The upper substrate and the lower substrate were air-tightly sealed by an epoxy-based adhesive so as to block moisture such that the display capability of the electrophoretic display device is suppressed from deteriorating due to moisture.

However, it is difficult for the transparent resin film to completely block moisture like a glass substrate. Although the upper substrate and the lower substrate made of the transparent resin film are air-tightly sealed like JP-A-2005-31541, it is difficult to completely block moisture and a small amount of moisture may permeate between the sealed both substrates. Although a moisture prevention material (dry agent) is used, there is a limitation in the amount of moisture which can be prevented. As a result, if the substrates made of a flexible material such as the transparent resin film are used, it is difficult to completely seal the space between the substrates to prevent the organic TFT from being influenced by humidity.

### SUMMARY

An advantage of some aspects of the invention is that it is provides a method of driving an organic transistor, which is capable of suppressing moisture in an atmosphere of the organic transistor and suppressing a characteristic variation due to the influence of moisture, and an electrophoretic display device.

According to an aspect of the invention, there is provided a method of driving an organic transistor formed on a substrate, wherein the substrate is sealed by a sealing material, and a bias voltage for compensating for threshold voltage of the organic transistor is supplied to the organic transistor at least at the time of an operation of the organic transistor.

According to the method of driving the organic transistor of the invention, the organic transistor is isolated from the atmosphere by the sealing and the bias voltage for compensating for the threshold voltage is supplied in a state in which the influence of the atmosphere is suppressed. The bias voltage is supplied to the variation in threshold voltage, which occurs in the organic transistor due to the influence of the atmosphere which cannot be suppressed by the sealing.

The bias voltage for compensating for the threshold voltage may compensate for the threshold voltage of the organic transistor, which varies due to influence of moisture, in a direction of the threshold voltage before a variation due to the influence of moisture.

By this configuration, the bias voltage compensates for the threshold voltage of the organic transistor, which varies due to influence of moisture, in the direction of the threshold voltage before the variation due to the influence of moisture. That is, even in the organic transistor of which the threshold voltage varies due to the influence of moisture, the organic transistor can be suitably driven only by applying the gate voltage, without considering the variation in threshold voltage.

In the method of driving the organic transistor, the sealing material may have flexibility and the substrate may have flexibility.

By this configuration, even when the sealing material and the substrate have flexibility, the organic transistor can be suitable driven. That is, even the organic transistor sealed by a flexible material which cannot completely block moisture can be driven with suitable operation characteristics by supplying the bias voltage for compensating for the variation in threshold voltage.

In the method of driving the organic transistor, the sealing may be made at relative humidity of 20% or less in a sealed atmosphere.

By this configuration, since the relative humidity is 20% or less in the sealed atmosphere, the variation in threshold voltage of the organic transistor is in a constant range. Accordingly, it is possible to readily perform the compensation by applying the bias voltage for compensating for the threshold voltage is facilitated and to readily set the value of the bias voltage for compensating for the threshold voltage.

In the method of driving the organic transistor, the bias voltage may be supplied to a gate electrode.

By this configuration, since the bias voltage for compensation is supplied to the gate electrode, it is possible to compensate for the variation in threshold voltage generated in the organic transistor and to drive the organic transistor with the suitable operation characteristics.

In the method of driving the organic transistor, the organic transistor formed on the substrate may have a back gate electrode and the bias voltage may be supplied from the back gate electrode.

By this configuration, since the organic transistor has the back gate electrode, the bias voltage for compensating for the threshold voltage can be supplied from the back gate electrode. That is, the organic transistor can be driven with the suitable operation characteristics by supplying the bias voltage for compensating for the variation in threshold voltage to the organic transistor, without varying the data signal applied to the gate electrode of the organic transistor.

In the method of driving the organic transistor, the bias voltage may be supplied to a plurality of organic transistors formed on the substrate.

By this configuration, since the bias voltage is supplied to the plurality of organic transistors formed on the substrate, it is possible to facilitate the control method or the circuit configuration for supplying the bias voltage.

In the method of driving the organic transistor, the bias voltage may be equal to or less than a voltage for driving the organic transistor.

By this configuration, since the bias voltage supplied to the organic transistor is equal to or less than the voltage for driving the organic transistor, it is possible to simplify the circuit configuration for supplying the bias voltage without requiring, for example, a separate voltage.

According to another aspect of the invention, there is provided an electrophoretic display device including: a transparent counter substrate having a common electrode; a device substrate which faces the counter substrate and has pixel electrodes to which voltages are supplied from organic transistors; a dispersion system interposed between the common electrode and the device substrate; electrophoretic particles which migrate in the dispersion system on the basis of electric fields generated between the common electrode and the pixel electrodes; and a sealing material which seals the common electrode and the counter substrate and performs isolation from an external atmosphere, wherein the organic transistors are driven by the method of driving the organic transistor.

According to the electrophoretic display device of the invention, since the organic transistor is sealed by the sealing material and the bias voltage for compensating for the threshold voltage is supplied, the influence of the atmosphere is suppressed and the variation in threshold voltage is compensated for. Accordingly, it is possible to drive the organic transistor with the suitable operation characteristics and to suppress deterioration in display capability of the electrophoretic display device having the organic transistor.

### BRIEF DESCRIPTION OF THE DRAWINGS

The invention will be described with reference to the accompanying drawings, wherein like numbers reference like elements.

FIG. 1 is an overall plan view showing a display device having electrophoretic particles according to an embodiment of the invention.

FIG. 2 is a plan view showing a planar structure of a display panel according to the present embodiment.

FIG. 3 is a cross-sectional view taken along line III-III showing the cross-sectional structure of the display device according to the present embodiment.

FIG. 4 is a cross-sectional view showing the cross-sectional structure of the display panel according to the present embodiment.

FIG. 5 is a cross-sectional view showing the cross-sectional structure according to the present embodiment.

FIG. 6 is a circuit diagram showing the circuit configuration of a device substrate according to the present embodiment.

FIG. 7 is a circuit diagram showing an equivalent circuit of a pixel portion according to the present embodiment.

FIG. 8 is a graph showing the relative humidity of the organic transistor vs. the threshold variation characteristics, wherein FIG. 8A is a graph showing a case where an environmental temperature is 20 degrees, FIG. 8B is a graph showing a case where an environmental temperature is 40 degrees, FIG. 8C is a graph showing a case where an environmental temperature is 60 degrees, and FIG. 8D is a graph showing a case where an environmental temperature is 80 degrees.

FIG. 9 is a graph showing the off current characteristics of the organic transistor according to the present embodiment, wherein FIG. 9A is a graph showing a case where an environmental temperature is 20 degrees, FIG. 9B is a graph showing a case where an environmental temperature is 40 degrees, FIG. 9C is a graph showing a case where an environmental temperature is 60 degrees, and FIG. 9D is a graph showing a case where an environmental temperature is 80 degrees.

FIG. 10 is a graph showing the shift of the threshold voltage of the organic transistor.

### DESCRIPTION OF EXEMPLARY EMBODIMENTS

Hereinafter, a method of driving an organic transistor and an electrophoretic display device according to an embodiment of the invention will be described with reference to the accompanying drawings.

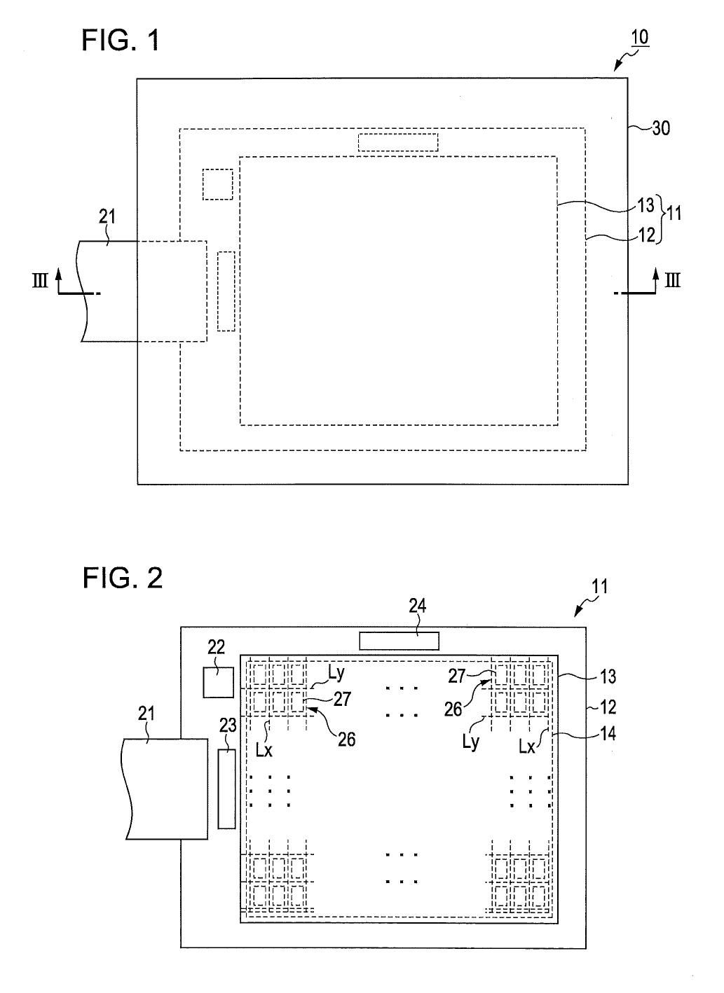

FIG. 1 is an overall plan view showing a display device according to the embodiment of the invention.

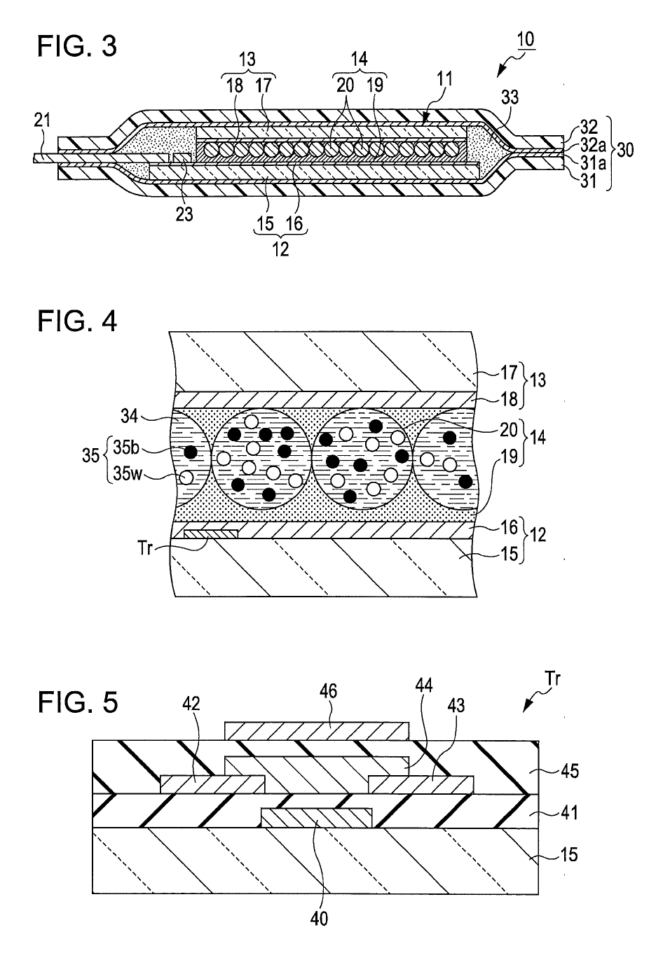

As shown in FIG. 1, the electrophoretic display device (display device) 10 includes a display panel 11 sealed by a sealing material 30. The display panel 11 is a display panel for displaying a predetermined pattern using an electrophoretic phenomenon. A flexible printed circuit board (FPC) 21, which connects the display panel 11 with an external power source or a control device and transmits/receives an electric signal, is connected to the left side of the display panel 11. As shown in FIG. 3, the overall outer surface of the display panel 11 and a portion of the FPC 21 are covered with the sealing material 30 for isolation from an external atmosphere.

Now, the detailed configuration of the display panel 11 will be described.

FIG. 2 is a plan view showing the planar structure of the display panel 11.

In FIG. 2, the display panel 11 includes a device substrate 12 and a counter substrate 13. An electrophoretic display layer 14 is interposed between the device substrate 12 and the counter substrate 13, as shown in FIG. 3.

As shown in FIG. 3, the device substrate 12 has a rear substrate 15 having flexibility, on which a formation layer 16 is formed on one surface thereof (an upper surface, in FIG. 3). The rear substrate 15 is made of a thermoplastic resin material or a thermosetting resin material having an excellent flexibility or elasticity, such as polyethylene terephthalate, polycarbonate, polyimide or polyethylene. A plurality of conductive layers and insulating layers, for example, an organic transistor Tr (see FIG. 4), a pixel electrodes and various types of wirings, are formed in the formation layer 16. Although, in the present embodiment, a p-type channel organic transistor Tr is described, the configuration of the organic transistor may be an n-type channel organic transistor or other types of organic transistors.

As shown in FIG. 5, in the organic transistor Tr, a back gate electrode 40 is formed on the upper surface of the rear substrate 15 and a first insulating layer 41 (formation layer 16) is formed on the upper surface thereof. On the upper surface of the first insulating layer 41, a source electrode 42 and a drain electrode 43 are formed at the same distance from the back gate electrode 40, and an organic semiconductor layer 44 is formed between the electrodes 42 and 43. A second insulating layer 45 (formation layer 16) is formed to cover all the first insulating layer 41, the source electrode 42, the drain electrode 43 and the organic semiconductor layer 44, and a gate electrode 46 is formed thereon at a position corresponding to the organic semiconductor layer 44. At this time, all the electrodes 40, 42, 43 and 46 are made of a conductive material, for example, metal such as gold, copper or aluminum, indium-tin-oxide, or an electronic conductive high polymer such as polyaniline. In contrast, the insulating layers 41 and 45 are made of an insulating material, for example, at least one or two of polymethylmethacrylate, polyvinylphenol, polyimide, polystyrene, polyvinyl alcohol and polyvinyl acetate. The organic semiconductor layer 44 is made of, for example, pentacene, arylamine, P3HT, PQT, F8T2 or DPh-BTBT.

The counter substrate 13 includes a transparent substrate 17 having flexibility, on which a common electrode 18 is formed on one surface thereof (a lower surface in FIG. 3). The transparent substrate 17 is made of a thermoplastic resin material or a thermosetting resin material having an excellent flexibility or elasticity, such as polyethylene terephthalate, polycarbonate, polyimide or polyethylene. The common electrode 18 is made of a transparent conductive material, for example, indium-tin-oxide or an electronic conductive high polymer such as polyaniline.

The electrophoretic display layer 14 is composed of a plurality of microcapsules 20 which is integrally formed by a binder 19. As shown in FIG. 4, an electrophoretic dispersion medium 34 functioning as a dispersion system and electrophoretic particles 35 are filled in each of the microcapsules 20. The electrophoretic particles 35 include white particles 35w charged with a positive or negative polarity and black particles 35b charged with a polarity different from that of the white particles 35w and migrate in the electrophoretic dispersion medium 34 in directions of electric fields applied to the microcapsules 20.

The microcapsule 20 is made of, for example, an acacia/gelatin-based compound or a urethane-based compound. The electrophoretic dispersion medium 34 is composed of, for example, water, methanol and ethanol. The electrophoretic particle 35 is made of, for example, aniline black, carbon black or titanium dioxide.

The overall outer surface of the display panel 11 is covered with the sealing material 30, as shown in FIGS. 1 and 3. The sealing material 30 includes a rear-surface sealing material 31 having a film shape and a transparent front-surface sealing material 32 having a film shape, and adhesives 31a and 32a are respectively formed on the facing surfaces of the sealing materials. The rear-surface sealing material 31 is adhered to the lower surface of the rear substrate 15 configuring the device substrate 12 through the adhesive 31a. The front-surface sealing material 32 is adhered to the upper surface of the transparent substrate 17 configuring the counter substrate 13 through the adhesive 32a.

The front-surface sealing material 32 includes an outer high molecular resin film layer and an inner inorganic material barrier layer and prevents moisture from permeating into the display panel 11. The high molecular resin film layer is made of, for example, polyethylene terephthalate, polyethylene, polypropylene, ethylene-vinyl alcohol copolymer resin, or a liquid crystal polymer film. The inorganic material barrier layer is made of, for example, lamellar silicate (silicon oxide), silicon nitride, aluminum oxide, indium-tin-oxide, or a fluorine-doped tin oxide compound. The rear-surface sealing material 31 may be formed of the same composition and material as the front-surface sealing material 32 or may be made of a metal material, such as a copper foil or aluminum, or a metal-coated resin film because transparency is not required.

The adhesives 31a and 32a are made of an adhesive such as a hot-melt adhesive.

The rear-surface sealing material 31 and the front-surface sealing material 32 substantially have the same area larger than that of the display panel 11. The both sealing materials 31 and 32 are adhered to each other by the adhesives 31a and 32a at the outer circumference of the display panel 11 such that the display panel 11 is sealed and is isolated from the external atmosphere. As shown in FIG. 3, the FPC 21 is connected to the left side of the device substrate 12, but the both sealing materials 31 and 32 are adhered to the both surfaces of the FPC 21 through the adhesives 31a and 32a so as to seal the display panel 11. The FPC 21 dose not transmit the atmosphere and the display panel 11 is sealed by covering the outer surface thereof with the both sealing materials 31 and 32, thereby realizing isolation from the external atmosphere.

As shown in FIG. 3, an adhesive 33 is filled between the display panel 11 and the both sealing materials 31 and 32 at the outer circumference of the display panel 11. The adhesive 33 is preferably made of a material which does not deteriorate the flexibility of the display device 10.

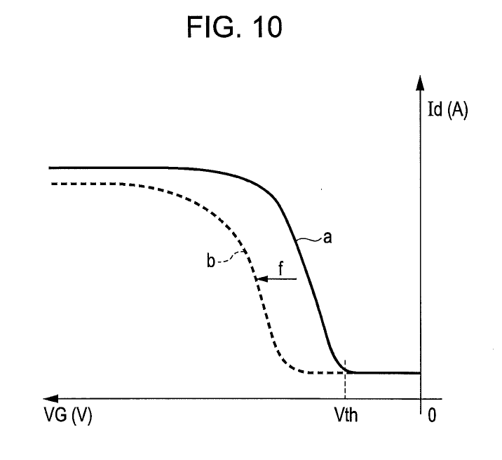

Accordingly, the operation characteristic and more particularly a threshold voltage Vth (see FIG. 10) of the organic transistor Tr generally varies in a minus direction due to the influence of the atmosphere, but is isolated from the atmosphere by the sealing of the sealing material 30 such that the influence is suppressed.

Since the threshold voltage Vth of the organic transistor Tr varies in the minus direction due to the influence of moisture, in the present embodiment, the display panel 11 is sealed by the sealing material 30 in an atmosphere in which an ambient temperature is 20 degrees and relative humidity is 0.9% or less, that is, an atmosphere in which the amount of moisture is 0.18 g/m³ or less.

This amount of moisture can hold relative humidity of 20% at a temperature of −20 degrees when a minimum temperature is −20 degrees as an operation environment of the display panel 11. That is, it is preferable that the display panel 11 is sealed when the amount of moisture in the atmosphere is 0.18 g/m³ or less in a dry room or chamber.

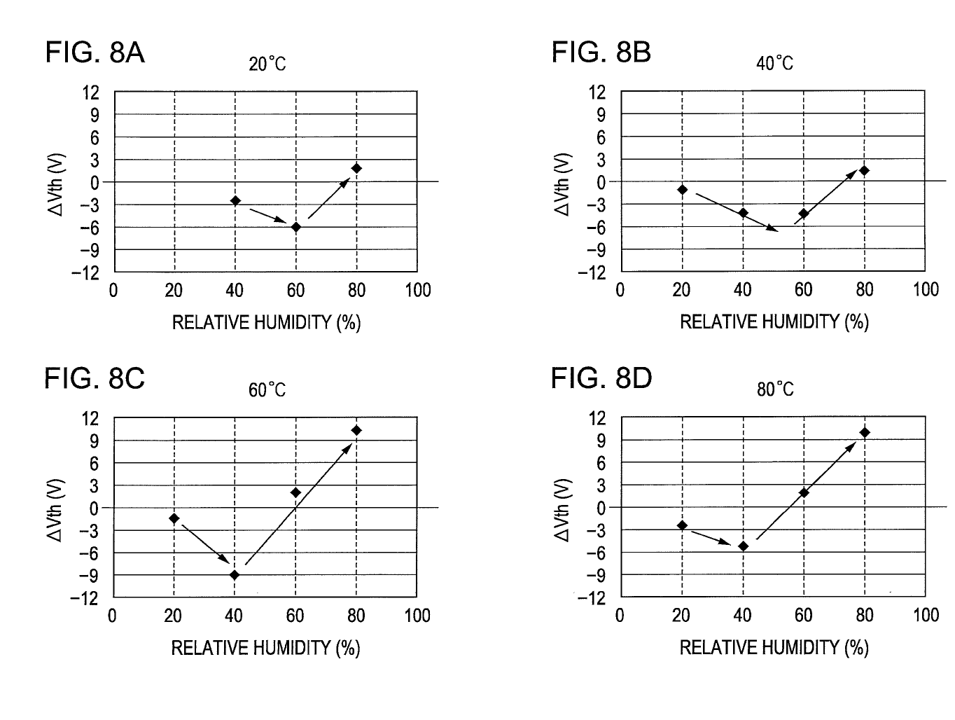

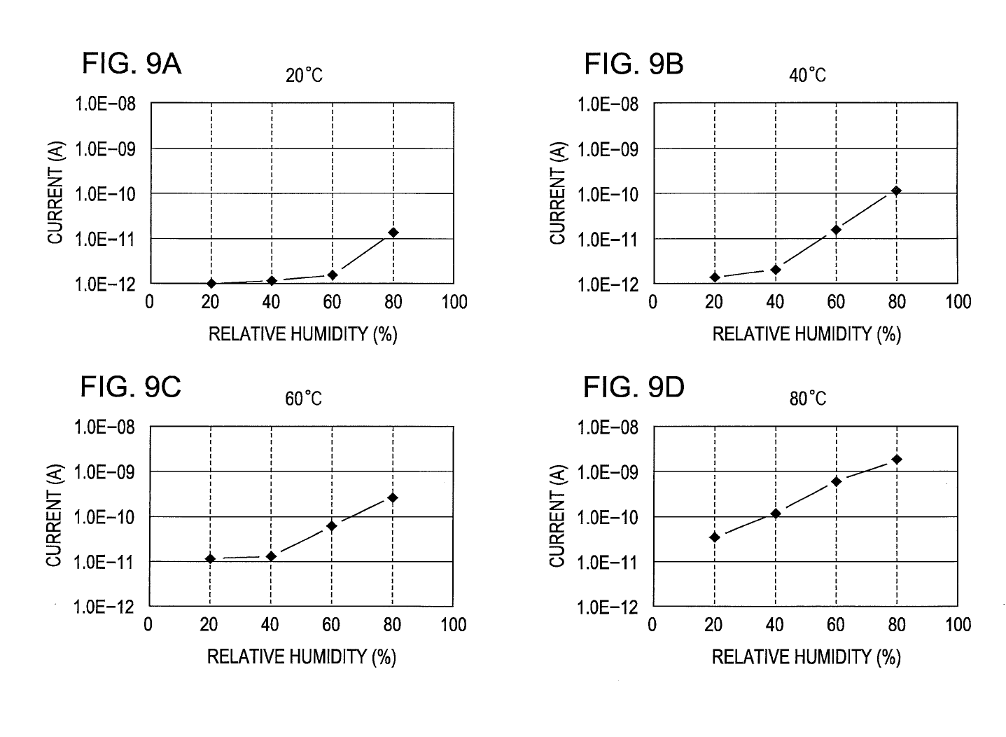

In more detail, FIG. 8 shows a state in which a threshold variation ΔVth of the organic transistor Tr varies according to environmental humidity (20 degrees, 40 degrees, 60 degrees and 80 degrees), and FIG. 9 shows a state in which the off current of the organic transistor Tr varies according to environmental humidity (20 degrees, 40 degrees, 60 degrees and 80 degrees). The value “0” of the threshold variation ΔVth of FIG. 8 is a value of the threshold voltage Vth of the organic transistor Tr in a nitrogen environment, that is, a non-humidity atmosphere.

In FIG. 8, a minimum point of the threshold variation ΔVth (variation in a most minus potential direction) is present in the vicinity of the relative humidity of 60% and the minimum point may have a highest probability that causes deterioration in display capability of the display panel 11. In case where the environmental temperature is 20 degrees, 40 degrees, 60 degrees and 80 degrees, the tendencies of the threshold variation ΔVth due to the relative humidity are slightly different from one another but substantially similar to one another, and the minimum points thereof are present in a range of the humidity of 40% to 60%.

In either case, it is preferable that the threshold variation ΔVth is “0”, in order to suitable control the organic transistor Tr.

Meanwhile, even in a case where the voltage of the gate electrode 46 is at a H level and the organic transistor Tr is in an off state, the off current flows between the source electrode 42 and the drain electrode 43. As the organic transistor Tr, a transistor having low off current, that is, a high on/off ratio of current, is preferable. As shown in FIGS. 9A to 9D, even in any environmental temperature, the off current increases as the relative humidity increases. Accordingly, it is preferable that the relative humidity is low, from the viewpoint of the suppression of the off current.

Accordingly, from the data of FIGS. 8 and 9, in the present embodiment, the threshold variation ΔVth is close to “0” and the relative humidity of 20% or less is selected as the relative humidity suitable for the control of the organic transistor Tr having low off current. In the atmosphere in which the display panel 11 is sealed by the sealing material 30, the environmental temperature is set to −20 degrees or more and the relative humidity is set to 20% or less.

Meanwhile, the device substrate 12 is composed of an active matrix type substrate. As shown in FIG. 2, on the upper surface of the device substrate 12, the FPC 21 is electrically connected, and a control circuit 22, a scan line driving circuit 23 and a data line driving circuit 24, all of which generate respective signals on the basis of a signal transmitted/received through the FPC 21, are provided.

On the upper surface of the device substrate 12, that is, the formation layer 16, a plurality of scan lines Ly, which substantially extend over the overall horizontal-direction width in FIG. 2, are arranged. The scan lines Ly are electrically connected to the scan line driving circuit 23 provided at one side of the device substrate 12. On the formation layer 16, a plurality of data lines Lx, which substantially extend over the overall vertical-direction width in FIG. 2, are arranged. The data lines Lx are electrically connected to the data line driving circuit 24 provided at an upper side of the device substrate 12 in FIG. 2.

In the formation layer 16, a plurality of pixels 26 which are connected to corresponding scan lines Ly and data lines Lx and are arranged in a matrix are formed at intersections in which the scan lines Ly and the data lines Lx intersect each other. Each of the pixels 26 has a control device such as the organic transistor Tr or a light transmission pixel electrode 27 made of a transparent conductive film.

Next, the electrical configuration of the display panel 11 will be described with reference to FIGS. 2, 6 and 7.

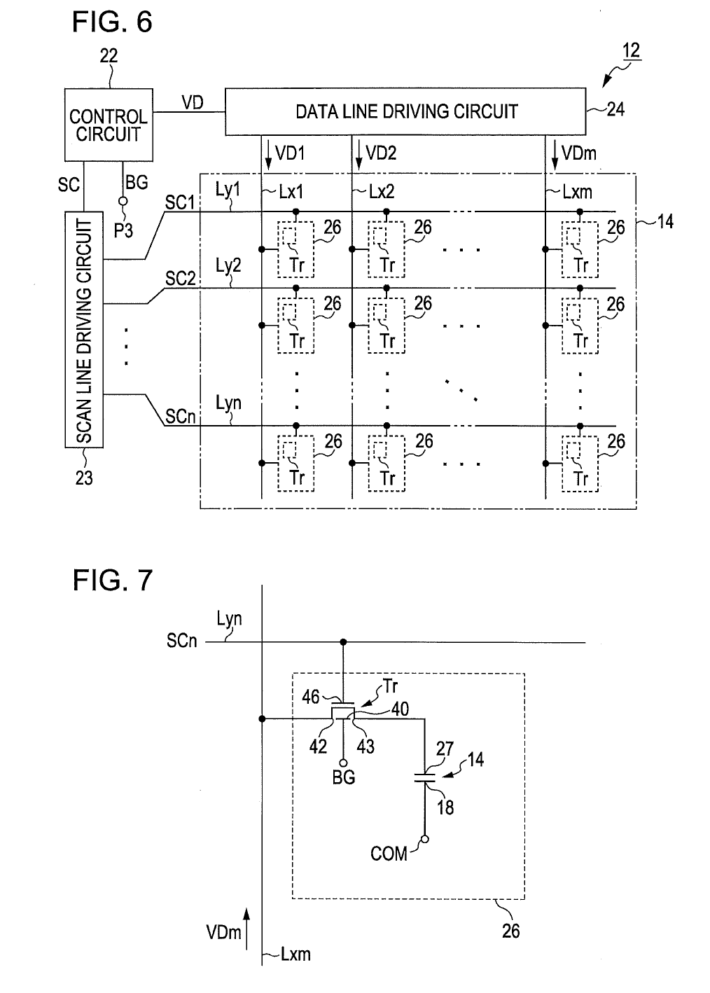

FIG. 6 is a circuit diagram showing an active matrix type circuit formed on the device substrate 12.

The data lines Lx shown in FIG. 2 respectively correspond to m data lines Lx1, Lx2, . . . , and Lxm shown in FIG. 6 (m is a natural number) and the scan lines Ly shown in FIG. 2 respectively correspond to n scan lines Ly1, Ly2, . . . , and Lyn shown in FIG. 6 (n is a natural number).

That is, the data lines Lx1 to Lxm are electrically connected to the data line driving circuit 24 and the scan lines Ly1 to Lyn are electrically connected to the scan line driving circuit 23. The pixels 26 formed at the intersections of the data lines Lx1 to Lxm and the scan lines Ly1 to Lyn are connected to corresponding data lines Lx1 to Lxm and corresponding scan lines Ly1 to Lyn.

FIG. 7 shows a pixel circuit of a pixel 26 which is formed in correspondence with an intersection of an m^{th} data line Lxm and an n^{th} scan line Lyn. The pixel 26 includes one organic transistor Tr and the electrophoretic display layer 14 having a width corresponding to the pixel electrode 27.

The gate electrode 46 of the organic transistor Tr is connected to the n^{th} scan line Lyn. The source electrode 42 of the organic transistor Tr is connected to the m^{th} data line Lxm. The drain electrode 43 of the organic transistor Tr is connected to the pixel electrode 27. The common electrode 18 is formed at a position facing the pixel electrode 27 with the electrophoretic display layer 14 interposed therebetween. The common electrode 18 is connected to a common terminal COM.

A predetermined bias voltage BG is applied to the back gate electrode 40 of the organic transistor Tr. The scan line driving circuit 23 selects one scan line among the n scan lines Lyn provided on the device substrate 12 in order of Ly1, Ly2, . . . , Lyn-1, and Lyn from the top to the bottom of a screen in the present embodiment, on the basis of a vertical synchronization signal transmitted through the FPC 21. The scan line driving circuit 23 outputs scan signals SC1 to SCn (n is a natural number) corresponding to the selected scan line. Timings when data signals VD1 to VDm output from the data line driving circuit 24 are supplied to the pixels 26 on the selected scan lines are controlled by the scan signal SC1 to SCn.

The data line driving circuit 24 generates the data signals VD1 to VDm corresponding to display data. In the pixels 26 on the scan lines Ly1 to Lyn selected by the scan signals SC1 to SCn sequentially output from the scan line driving circuit 23, the organic transistors Tr thereof are set to an on state. Accordingly, the data signals VD1 to VDm output from the data line driving circuit 24 to the pixels 26 through the data lines Lx1 to Lxm are supplied to the pixel electrodes 27 through the organic transistors Tr. That is, electric fields based on the voltages of the data signals VD1 to VDm occur between the pixel electrodes 27 and the common electrode 18 which face each other with the electrophoretic display layer 14 interposed therebetween. On the basis of the electric fields which occur between the pixel electrodes 27 and the common electrode 18, the white particles 35w and the black particles 35b as the electrophoretic particles 35 move toward any one of the pixel electrode 27 or the common electrode 18 having a potential corresponding to the polarity thereof and an image based on the white or black color is displayed on the surface of the display panel 11.

The control circuit 22 is electrically connected to the scan line driving circuit 23 and the data line driving circuit 24. The control circuit 22 outputs a scan line timing signal SC to the scan line driving circuit 23 and outputs a data timing signal VD to the data line driving circuit 24. The control circuit 22 has a bias voltage output terminal P3. The bias voltage output terminal P3 is electrically connected to the back gate electrodes 40 of all the organic transistors Tr on the device substrate 12 through a wiring (not shown). The control circuit 22 detects the operations of the organic transistors Tr on the basis of the scan line timing signal SC and the data timing signal VD respectively output to the scan line driving circuit 23 and the data line driving circuit 24 and supplies the predetermined bias voltage BG to the back gate electrodes 40 of the organic transistors Tr.

The bias voltage BG is a back gate voltage for suppressing the threshold voltage Vth of the organic transistor Tr from being shifted in a minus direction and is set to a predetermined voltage between a L level (0V in the present embodiment) and a H level (the driving voltage in the present embodiment) in the present embodiment.

That is, as shown in FIG. 10, if the water molecule (moisture) exists in the organic semiconductor, a weak charge interaction state occurs in the radical cation and the water molecule. Since this state is a quasi-stable state in energy, larger activation energy is necessary for returning a radical cation to a neutral state. Accordingly, the radical cation is fixed while holding a positive charge and cannot function as a carrier. Accordingly, the amount of current flowing between the source electrode 42 and the drain electrode 43 is reduced and thus the minus shift of the threshold voltage Vth occurs.

Accordingly, when the bias voltage BG is applied to the back gate electrode 40 of the organic transistor Tr, the bias voltage BG generates an electric field between the gate electrode 46 and the back gate electrode. As a result, energy necessary for enabling the quasi-stable radical cation to function as the carrier is supplied and the radical cation functions as the carrier such that it is possible to suppress the threshold voltage Vth from being shifted in the minus direction.

Next, the operation of the display device 10 having the above-described configuration will be described.

In the present embodiment, the bias voltage BG for compensating for the threshold voltage was applied to the back gate electrode 40 of the organic transistor Tr. Accordingly, it is possible to suppress the threshold voltage Vth of the organic transistor Tr from being shifted in the minus direction based on the elapse of the operation time. As a result, since the minus shift of the threshold voltage Vth based on the elapse of the operation time is suppressed and the organic transistor Tr can be always driven at a constant timings, it is possible to provide the electrophoretic display device 10 having excellent display characteristics.

In addition, since the atmosphere in which the display panel 11 is sealed by the sealing material 30 is set to an environmental temperature of −20 degrees or more and relative humidity of 20% or less, the organic transistor Tr, of which the threshold variation ΔVth is close to “0” and the off current is low, can be obtained.

As described above, according to the method of driving the organic transistor and the electrophoretic display device according to the present embodiment, the following effects can be obtained.

(1) In the present embodiment, since the display panel 11 is sealed by the rear-surface sealing material 31 and the front-surface sealing material 32, both of which prevent permeation of moisture, the operation characteristics and, more particularly, a variation in threshold voltage Vth of the organic transistor Tr due to the influence of the atmosphere and, more particularly, moisture are suppressed. As a result, the organic transistor Tr can be suitably driven.

(2) In the present embodiment, the bias voltage BG for compensating for the minus shift of the threshold voltage Vth is applied to the back gate electrode 40 of the organic transistor Tr at the time of the operation of the organic transistor Tr. Accordingly, even with respect to the variation in threshold voltage Vth, which occurs in the organic transistor, due to the influence of the atmosphere which cannot be completely prevented by sealing, the organic transistor Tr can be driven with suitable operation characteristics by supplying the bias voltage BG for compensating for the threshold voltage. As a result, the voltage of the gate electrode 46 suppresses the variation in threshold voltage Vth so as to suppress deterioration in display capability of the display device.

The threshold voltage Vth of the organic transistor Tr is gradually shifted in the minus direction according to the number of times of driving, due to the influence of moisture, but, in this case, the threshold variation ΔVth due to the influence of moisture is compensated for by supplying the bias voltage BG. As a result, even when the influence of moisture on the organic transistor Tr cannot be completely suppressed by sealing, the organic transistor Tr can be suitably driven.

(3) In the present embodiment, the threshold variation ΔVth which occurs due to moisture included in the sealed display panel 11 is compensated for such that the threshold voltage Vth in a non-humidity state is realized. Accordingly, even when the voltage is applied to the gate electrode 46 of the organic transistor Tr, of which the threshold voltage Vth varies, without considering the variation in threshold voltage Vth, the organic transistor Tr can be suitably driven.

(4) In the present embodiment, the display device 10 includes flexible materials such as the rear substrate 15, the transparent substrate 17, the rear-surface sealing material 31 and the front-surface sealing material 32, and the organic transistors Tr which are resistant against bending. Accordingly, even in the organic transistor Tr in the configuration using the flexible material which cannot completely block moisture, the organic transistor Tr can be held with suitable operation characteristics by supplying the bias voltage BG to compensate for the variation in threshold voltage Vth.

The display device 10 has flexibility and thus can be used as electronic paper requiring flexibility.

(5) In the present embodiment, since the display panel 11 is sealed at relative humidity of 20% or less, the amount of moisture in the display panel 11 is equal to or less than the relative humidity of 20%. Accordingly, since the characteristic variation of the threshold variation ΔVth of the organic transistor Tr is in a predetermined range, the compensation due to the application of the bias voltage BG for compensating for the threshold voltage is facilitated.

(6) In the present embodiment, the organic transistor Tr has the back gate electrode 40 and the bias voltage BG is supplied from the back gate electrode 40. Accordingly, the organic transistor Tr can be driven with suitable operation characteristics by supplying the bias voltage BG for compensating for the threshold voltage to the organic transistor Tr without changing the scan signals SC1 to SCn applied to the gate electrode 46 of the organic transistor Tr.

(7) In the present embodiment, since the bias voltage BG is supplied to all the organic transistor Tr formed on the substrate at once, it is possible to facilitate the control method or the circuit configuration for supplying the bias voltage BG.

(8) In the present embodiment, since the voltage level of the bias voltage BG is between the H level and the L level, it is possible to simplify the circuit configuration for supplying the bias voltage without requiring, for example, a separate voltage.

(9) In the present embodiment, the organic transistor Tr is sealed by the sealing material 30 and the threshold variation ΔVth of the organic transistor Tr is corrected by the bias voltage BG. Accordingly, it is possible to configure the electrophoretic display device capable of suppressing deterioration in display capability.

### Other Embodiments

The above-described embodiment may be, for example, implemented by the following aspects.

Although, in the above-described embodiment, the bias voltage BG is applied to the back gate electrode 40, the bias voltage BG may be added to the scan signals SC1 to SCn if it is in a range of the withstanding voltage of the organic transistor Tr. In this case, the back gate electrode of the organic transistor Tr may be omitted.

In the above-described embodiment, the rear substrate 15, the transparent substrate 17, the rear-surface sealing material 31 and the front-surface sealing material 32 configuring the display device 10 are flexible. However, the invention in not limited to this and at least some of the materials may not be flexible.

In the above-described embodiment, the display panel 11 is sealed by the sealing material 30 in an atmosphere in which an ambient temperature is 20 degrees and relative humidity is 0.9% or less, that is, an atmosphere in which the amount of moisture is 0.18 g/m³ or less. However, the ambient temperature or the relative humidity at the time of sealing is not limited to this. In the environment using the display device 10, the relative humidity may be 20%, the amount of moisture may be increased if a minimum use temperature is increased and may be decreased if the minimum use temperature is decreased.

In the above-described embodiment, the relative humidity is 20% or less. However, the relative humidity is not limited to 20% or less. If the characteristics of the organic transistor for the relative humidity are known by experiments, the bias voltage BG suitable for the threshold variation ΔVth may be supplied to the organic transistor.

That is, the variation in threshold voltage of the organic transistor is quantitatively obtained by experiments and the relative humidity which can suitably control the organic transistor is selected from the data. Since the relationship between the relative humidity and the threshold variation is changed according to the method of forming the organic transistor, the threshold variation may be quantitatively obtained by experiments and the relative humidity which can suitably control the organic transistor may be selected from the data.

In the above-described embodiment, the threshold variation ΔVth of the organic transistor Tr varies as shown in FIG. 8 and the off current thereof varies as shown in FIG. 9 with respect to the temperature and the relative humidity. However, the organic transistor is not limited to have the characteristics shown in FIGS. 8 and 9. That is, the method of driving the organic transistor may be applied to any organic transistor of which the threshold voltage and the off current vary according to the relative humidity although the values thereof are different from those of the above-described organic transistor.

In the above-described embodiment, the display device 10 can be used in electronic paper. However, the display device 10 is not limited to this and can be used in an apparatus having a display device.

What is claimed is:

1. A method of driving an organic transistor formed on a substrate, wherein the substrate is sealed by a sealing material, and a bias voltage for compensating for threshold voltage of the organic transistor is supplied to the organic transistor at least at the time of an operation of the organic transistor.

2. The method according to claim 1, wherein the bias voltage for compensating for the threshold voltage compensates for the threshold voltage of the organic transistor, which varies due to influence of moisture, in a direction of the threshold voltage before a variation due to the influence of moisture.

3. The method according to claim 1, wherein:
the sealing material has flexibility, and
the substrate has flexibility.

4. The method according to claim 1, wherein the sealing is made at relative humidity of 20% or less in a sealed atmosphere.

5. The method according to claim 1, wherein the bias voltage is supplied to a gate electrode.

6. The method according to claim 1, wherein the organic transistor formed on the substrate has a back gate electrode and the bias voltage is supplied from the back gate electrode.

7. The method according to claim 1, wherein the bias voltage is supplied to a plurality of organic transistors formed on the substrate.

8. The method according to claim 1, wherein the bias voltage is equal to or less than a voltage for driving the organic transistor.

9. An electrophoretic display device comprising:
a transparent counter substrate having a common electrode;
a device substrate which faces the counter substrate and has pixel electrodes to which voltages are supplied from organic transistors;
a dispersion system interposed between the common electrode and the device substrate;
electrophoretic particles which migrate in the dispersion system on the basis of electric fields generated between the common electrode and the pixel electrodes; and
a sealing material which seals the common electrode and the counter substrate and performs isolation from an external atmosphere,
wherein the organic transistors are driven by the method of driving the organic transistor according to claim 1.
